(19) United States
(12) Patent Application Publication
(10) Pub. No.: US 2025/0045679 A1
(43) Pub. Date: Feb. 6, 2025

(54) NON-DELIBERATE SHRINK PREVENTION WITH PRESCRIPTIVE RECOMMENDATIONS

(71) Applicant: NCR Voyix Corporation, Atlanta, GA (US)

(72) Inventors: Itamar David Laserson, Givat Shmuel (IL); Shay Marom, Kiryat Tiv'on (IL)

(21) Appl. No.: 18/228,377

(22) Filed: Jul. 31, 2023

(51) Int. Cl. G06Q 10/0639; G06Q 10/067

(52) U.S. Cl. CPC G06Q 10/06398; G06Q 10/06395; G06Q 10/067

(57) ABSTRACT

Features attributable to non-deliberate cashier shrink are identified within a given store's historical transaction data. A machine-learning model is trained on the features to predict shrink events over a future interval of time. Each prediction is also associated with a specific prescriptive recommendation, which if followed, eliminates or otherwise mitigates the likelihood that the predicted shrink event occurs during the corresponding time interval. Each prediction can be specific to a given cashier for the future interval of time. The predictions and corresponding prescriptive recommendations can be provided to store managers in advance of a start of the future interval of time, which allows the manager to follow the prescriptive recommendations and potentially avoid the shrink events altogether.

### BACKGROUND

Non-deliberate shrink caused by a cashier's failure to scan barcodes or accurately enter produce/deli codes is a big concern in the retail industry. Computer-vision technologies exist to detect non-deliberate shrink, but these technologies fail to prevent the shrink.

According to recent studies, retailers in the U.S. alone lose $47 billion annually to shrink, which is roughly 2% of their revenue. A third of retail shrink is associated with shoplifting, mostly through self-checkout lanes. An additional 40% is employee-related shrink, which may be deliberate or non-deliberate due to lack of training.

Retailers invest billions in fraud detection solutions annually. Retailers widely agree that a solution that “prevents” shrink yields a much higher opportunity to cut losses.

### SUMMARY

In various embodiments, a system and methods for non-deliberate shrink prevention with prescriptive recommendations are provided. Factors attributed to non-deliberate shrink are identified as features, which are used to train a machine learning model (“model” and/or “MLM”) for predicting non-deliberate shrink events over a future interval of time by store, by terminal, and by cashier. A shrink event prediction may be associated with a specific prescriptive action, that if taken, may eliminate or otherwise mitigate the likelihood that shrink associated with the corresponding prediction occurs. The predictions and corresponding prescriptive recommendations may be provided to store managers in advance of the future interval of time to which they correspond to thereby proactively prevent the shrink.

In an embodiment, statistical metrics relevant to non-deliberate shrink are maintained for a given store with respect to each cashier or cashier category and/or with respect to all cashiers collectively at a given store. In an embodiment, reports for the statistical metrics are provided to the store managers at preconfigured time intervals to allow the managers to assess, train, monitor, and supervise underperforming cashiers who require individualized attention to reduce their non-deliberate shrink events.

### BRIEF DESCRIPTION OF THE DRAWINGS

FIG. 1 is a diagram of a system for non-deliberate shrink prevention with prescriptive recommendations, according to an example embodiment.

FIG. 2 is a diagram of a method for non-deliberate shrink prevention with prescriptive recommendations, according to an example embodiment.

FIG. 3 is a diagram of another method for non-deliberate shrink prevention with prescriptive recommendations, according to an example embodiment.

### DETAILED DESCRIPTION

A substantial portion of retail shrink is attributable to non-deliberate cashier shrink. Many employee-related shrink incidents are unintentional. An example of unintentional shrink by a cashier might include a cashier struggling to add specific items to a transaction. This can occur for a variety of reasons, such as hard-to-find or hard-to-scan barcodes, or a produce item that is unrecognized by the cashier during the checkout. Cashiers may be reluctant to hold up a line at the checkout in order to find the correct item code, resulting in an incorrect code being entered or the item code not being scanned altogether. These types of events cost retailers millions of dollars annually.

The technical solution provided herein eliminates or otherwise mitigates non-deliberate cashier shrink by training one or more machine learning models (“models” and/or “MLMs”) to identify contexts (i.e., shrink events) in which non-deliberate shrink is most likely to occur and to suggest prescriptive recommendations so as to avoid the shrink altogether. A variety of non-deliberate shrink features is identified and used along with a set of prescriptive recommendations to train the model(s). Known historical shrink and non-shrink events may be used as ground-truth data to train the models.

The features may include, by way of example only, cashier identifier, terminal identifier, store identifier, time of day, known busy times of each day, day of week, calendar date, basket size, item codes for the items in a given basket, total number of produce or deli items in the given basket, ratio of produce or deli items to non-produce and non-deli items in the given basket, average historical shrink events associated with a given cashier, a histogram depicting the distribution of shrink events by cashier, by time of day, day of week, and calendar date, etc. During training, each transaction is labeled as to whether it was or was not associated with a shrink event. Further, the type of shrink event, when present, can be labeled as well during training.

The output of the model is a prediction of the likelihood that a non-deliberate shrink event occurs in a next configured interval of future time, a corresponding cashier identifier and terminal identifier to which the prediction relates, and one or more known prescriptive recommendations, which can prevent the predicted shrink event from occurring or otherwise mitigate the likelihood that it occurs during the future time interval. The known prescriptive recommendations may be custom-defined by store and may include, by way of example only, training of relevant cashiers; real-time notifications (e.g., presented within a point-of-sale (POS) interface prior to payment processing) to certain cashiers asking them “did you scan all the items of the transaction”; training focused on notifying a cashier that the end of their shift (when the models may predict that shrink is more likely to occur generally and/or for a given cashier) will include a recorded training session to ensure they are properly identifying and accounting for each item in a given transaction; notifications to store managers to increase security and monitoring of certain cashiers during pre-defined times of day, such as during peak store hours likely to be the busiest; customized training of certain cashiers to facilitate memorization of the different types of produce and deli item codes along with how to quickly identify them through a transaction interface of the POS terminal during transactions; customized training of certain cashiers to demonstrate how to locate hard-to-find barcodes for various items (e.g., wet deli wrappers); and so forth.

The model(s) may also output predictions for those cashiers who do not require any special attention or training over a next interval of time. These cashiers are predicted to be less likely to be associated within any non-deliberate shrink events such that store managers can move supervision and monitoring activities away from these cashiers and focus on cashiers more likely to be associated with non-deliberate shrink events.

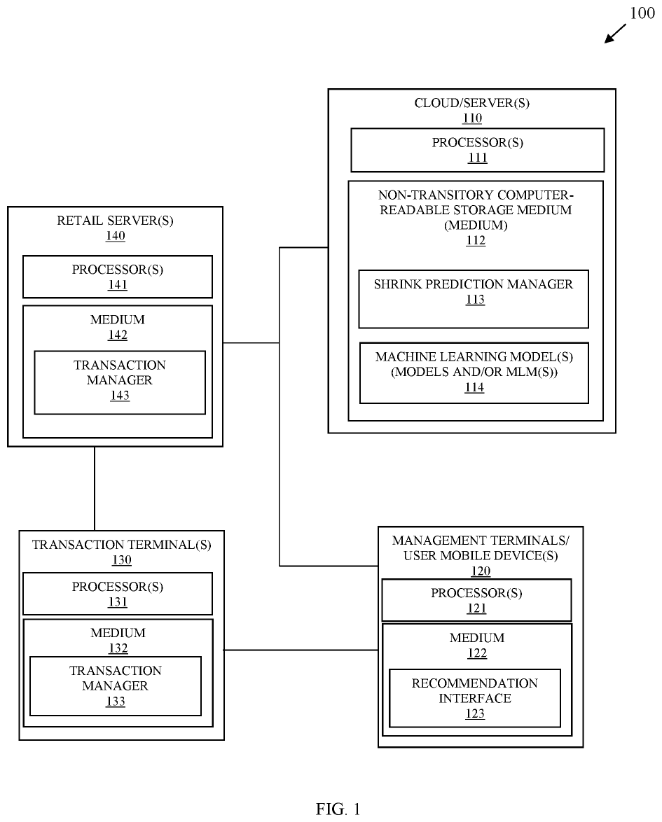

FIG. 1 is a diagram of a system/platform 100 for non-deliberate shrink prevention with prescriptive recommendations, according to an example embodiment. It is to be noted that the components are shown schematically in greatly simplified form, with only those components relevant to understanding of the embodiments being illustrated.

Furthermore, the various components (that are identified in system/platform 100) are illustrated and the arrangement of the components are presented for purposes of illustration only. It is to be noted that other arrangements with more or less components are possible without departing from the teachings of non-deliberate shrink prevention with prescriptive recommendations, presented herein and below.

System/platform 100 (hereinafter “system 100”) includes a cloud 110 or a server 110 (hereinafter just “cloud 110”), one or more management terminals/manager-operated user mobile devices 120, transaction terminals 130, and retail servers 140. Cloud 110 includes at least one processor 111 and a non-transitory computer-readable storage medium (hereinafter just “medium”) 112 that includes executable instructions for a shrink prediction manager 113, and one or more models/MLMs 114. When the instructions are provided to processor 111 from medium 112, this causes processor 111 to perform the operations discussed herein and below with respect to 113 and 114.

Each management terminal/management-operated mobile device 120 includes at least one processor 121 and medium 122, which includes instructions for a recommendation interface 123. When the instructions are provided to processor 121 from medium 122, this causes processor 121 to perform operations discussed herein and below with respect to 123.

Each terminal 120 includes at least one processor 131 and medium 132, which includes instructions for a transaction manager 133. When the instructions are provided to processor 131 from medium 132, this causes processor 131 to perform operations discussed herein and below with respect to 133.

Each retail server 140 includes at least one processor 141 and medium 142, which includes instructions for a transaction manager 143. When the instructions are provided to processor 141 from medium 142, this causes processor 141 to perform operations discussed herein and below with respect to 142.

Initially, historical transaction data associated with non-deliberate shrink events and not associated with shrink events is obtained from a given retail server 140 of a given retailer. The historical transaction data is segmented into training and testing data by predefined intervals of past time. The training data is further labeled with features, as discussed above. Both the training data and testing data include transactions that were associated with known non-deliberate shrink events and that were not associated with non-deliberate shrink events. The training data and testing data are balanced based on transactions having shrink events and transactions not having shrink events.

Predefined prescriptive recommendations are obtained from the given retailer as actions that the retailer believes would have prevented the non-deliberate shrink events for each transaction labeled with corresponding shrink events. That is, a type associated with each of the non-deliberate shrink event is mapped in a data structure to a corresponding retailer provided prescriptive recommendation. The types are also customizable by the retailer. In an embodiment, the types of non-deliberate shrink events include unable to scan an item code from packaging of the item, incorrect item code entered during peak business hours, incorrect item code entered during non-peak business hours, packaging that should include an item barcode but did not, and a failure to provide any item code for a given item. In an embodiment, the mapping between the shrink event types and the prescriptive recommendations can include one shrink event type mapped to two or more prescriptive recommendations. In an embodiment, the mapping between the shrink event types and the prescriptive recommendations can include one shrink event to one prescriptive recommendation. The prescriptive recommendations can include any of the above-noted recommendations, such as training focused on various aspects tailored to the environment and the cashier, increased supervision of a certain cashier during peak business hours, real-time notifications as reminders to a cashier during transactions identified as likely to be associated with non-deliberate cashier shrink events, etc.

The training data is also labeled with the corresponding prescriptive recommendations for each training transaction associated with a non-deliberate shrink event. The model 114 is trained to receive the labeled featured input and labeled prescriptive recommendations and generate as output a time series of predictions in a next interval of time for shrink events by cashier and/or by terminal 130.

In an embodiment, a variety of statistical metrics are derived and calculated from the historical transaction data and provided as features during training to the model 114. For example, histograms are derived to define distributions of the past shrink events by store, by cashier of store, by peak and non-peak business hours of the store, by calendar data, etc. In an embodiment, average rates of shrink by cashier and/or by terminal are also maintained. Shrink prediction manager 113 generates, updates, and maintains the statistical metrics as transaction data is provided from the retailer's server 140, such that the statistical metrics are up-to-date at any given point in time that model 114 is asked to provide non-deliberate shrink event predictions and the corresponding prescriptive recommendations to prevent the shrink events from occurring.

In an embodiment, one or more computer-vision applications evaluates the historical transaction data in view of video captured for the corresponding transactions and the computer-vision applications identify and flag the non-deliberate shrink events and shrink event types determined from the video and the corresponding historical transaction data. The shrink prediction manager 113 receives the flagged historical transaction data as the historical transaction data. That is, even historical transactions that may not have been flagged with a shrink event are captured through the computer-vision applications and identified as being associated with shrink within the historical transaction data by shrink prediction manager 113.

Following training, model 114 is tested on the segmented testing data. Once acceptable or predefined accuracy metrics are met, the model 114 is released to provide non-deliberate shrink event predictions along with corresponding prescriptive recommendations for a future interval of time by cashier and/or by terminal 130.

In an embodiment, as transaction data for a given transaction is processed at a given terminal 130, transaction manager 133 provides the transaction data in real time to shrink prediction manager 113. Each set of transaction data includes a cashier identifier, a terminal identifier, a store identifier, an optional customer identifier, a transaction identifier for the ongoing transaction being processed at the terminal 130, item identifiers for item codes scanned or entered by the cashier, prices of each item code, any voids or overrides performed by the cashier, etc. Shrink prediction manager 113 updates any statistical metrics for the store, the terminal, and the cashier based on the real-time transaction data and flags the transaction as being associated with a most-recent interval of time.

In an embodiment, the transaction manager 133 provides the transaction data in real time to transaction manager 143. At a preconfigured interval of time, shrink prediction manager 113 obtains transactions and their transaction data for a most-recent interval of time and updates any statistical metrics for the store, the terminal, and the cashier. In an embodiment, computer-vision applications evaluate transaction video and corresponding transaction data once received by the transaction manager 143 and any detected shrink events and corresponding event types are flagged such that shrink prediction manager 113 obtains the transaction data for the most-recent interval of time with known shrink events and event types labeled in the transaction data.

At a configured interval of time (e.g., an hour, every two hours, twice a day, once a day, etc.), shrink prediction manager 113 obtains the transaction data for the most recent interval of time for a given store of a retailer. Any statistical metrics are updated accordingly, and the labeled feature data for the transaction data of the most-recent interval of time along with any up-to-date statistical metrics for the store are provided as input to the model 114. Model 114 returns as output a time series set of shrink predictions by cashier, store, and/or terminal for a next future interval of time (e.g., next hour, next two hours, half a day, entire day, etc.), each prediction associated with or linked to one or more prescriptive recommendations.

In an embodiment, shrink prediction manager 113 provides the predictions and the corresponding prescriptive recommendations within recommendation interface 123 as an interactive heatmap. A layout of the store details the locations of the point-of-sale terminals operated by cashiers of the store. Each cashier is labeled via a name or cashier identifier on the corresponding terminals. The predictions are color coded based on their values on top of or adjacent to each cashier name/identifier. For example, darker shades of red correlate to a high probability of non-deliberate shrink. The heatmap is animated/played to illustrate the predictions of each cashier at each terminal within the store and their corresponding predicted non-deliberate shrink events over the future interval of time associated with the predictions. Each terminal and cashier depicted within the heatmap is selectable to obtain corresponding assigned prescriptive recommendations.

Shrink prediction manager 113 provides the time series of shrink predictions and corresponding prescriptive recommendations to recommendation interface 123 via an application programming interface (API). In an embodiment, predictions over a predefined percentage cause shrink prediction manager 113 or cause recommendation interface 123 to send a real-time alert notification to a given store manager's mobile device 120. A store manager interacts with recommendation interface 123 to receive detailed reports for the next future interval of time. The manager views the shrink predictions by time of day to identify specific cashiers and/or terminals of the store that are most likely to experience non-deliberate cashier shrink along with detailed and fine-grain prescriptive recommendations, which if followed, can avoid the predicted shrink altogether.

In an embodiment, shrink prediction manager 113 generates reports at preconfigured intervals of time (e.g., weekly, bi-weekly, monthly, quarterly, etc.). The reports are provided to the store manager via recommendation interface 123. The reports provide a summary of any statistical metrics by cashier, by all the cashiers as a whole of the store, and/or by categories assigned to the cashiers (e.g., new cashiers, experienced cashiers, low-performing cashiers, etc.). The reports compare each cashier against categories of cashiers or cashiers of the store as a whole. For example, cashier X encounters a non-deliberate shrink event on average twice per shift, the average cashier encounters a shrink event once every 4 shifts, and an experienced cashier encounters a shrink event once per month. The reports assist the manager in identifying those cashiers who are underperforming and require specialized training so as to improve their shrink statistical metrics. In an embodiment, the reports include the shrink event types so that the manager can identify specific issues that are problematic for each cashier. For example, most of a cashier's shrink events occur towards an end of the cashier's shift such that the manager can inform the cashier that recorded training will take place near the end of each shift for the cashier to monitor the cashier's improvement on shrink. Sometimes just knowing that one is being monitored will change the behavior of the cashier.

In an embodiment, a transaction interface of transaction manager 133 is enhanced to receive prescriptive recommendations via an API from shrink prediction manager 113. For example, shrink prescriptive manager 113 sends a message to transaction manager 133 that informs transaction manager 133 to display a notification through the transaction interface for every transaction that takes place during a set interval of time (for example, the next hour). The notification is to be presented to the cashier when a transaction during the interval of time moves to a payment state and the cashier has to acknowledge the message before entering the payment state. In an embodiment, the notification states “are you sure each item code was properly entered or scanned for this transaction?” In an embodiment, the notification is a message that stays on each transaction screen during the interval of time informing the cashier that transactions during the interval of time are being recorded for training and evaluation to ensure that the cashier is properly entering and recording each item in each of the transactions. In an embodiment, the notification is a message that stays on each transaction screen during the interval of time informing the cashier that the transactions for the interval of time are being monitored by a supervisor for cashier training evaluation purposes.

One now appreciates how system 100 is particularly beneficial for both predicting and proactively preventing non-deliberate shrink events associated with cashiers of a store. Model 114 is trained on specific features derived from transaction data that is known to be associated with non-deliberate cashier shrink. The model 114 provides a data-driven set of accurate predictions over a future interval of time, which identifies by cashier, by store, and by terminal where shrink is most likely to occur and what specific actions can be proactively taken to prevent the shrink from happening. Store managers are provided the predictions and prescriptive recommendations to eliminate ad hoc and discretionary practices associated with identifying and correcting non-deliberate shrink and to improve cashier performance and productivity within a given store. Additionally, periodic reports are provided to the managers to better understand what each cashier needs to reduce or eliminate their non-deliberate shrink such that the manager can proactively address the needs through training, supervision, and/or monitoring.

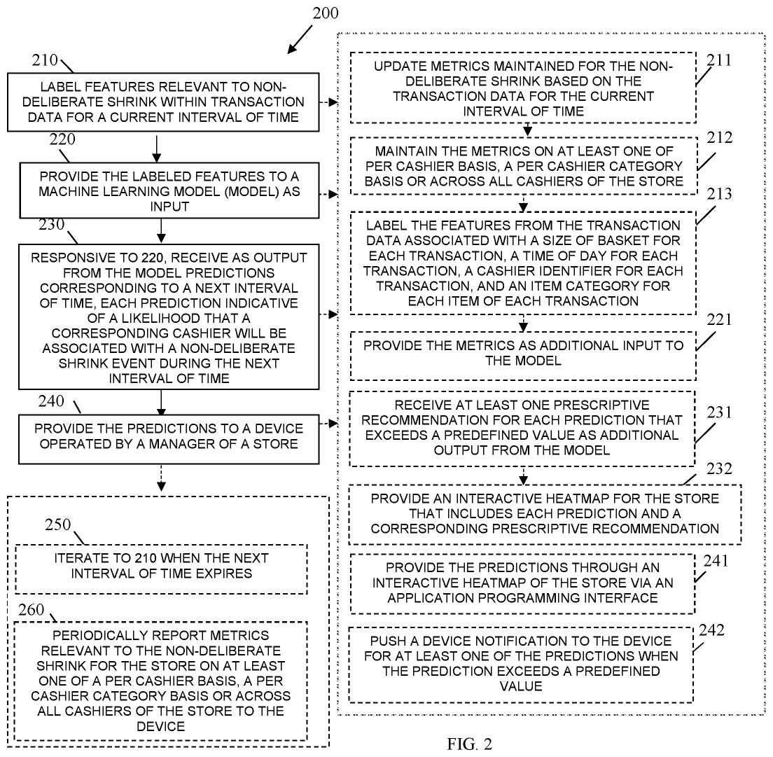

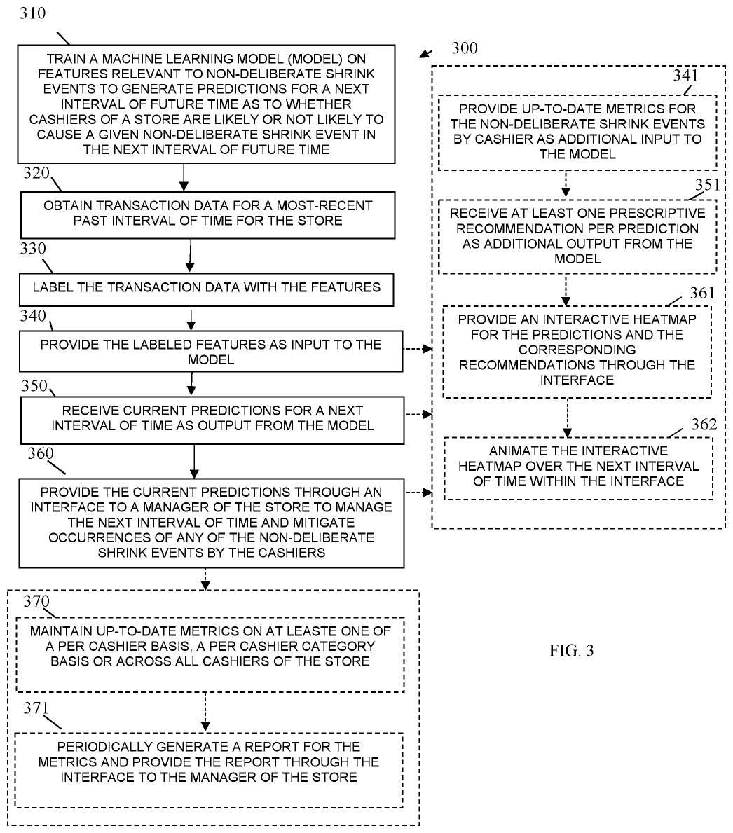

The above-referenced embodiments and other embodiments are now discussed within FIGS. 2-3. FIG. 2 is a diagram of a method 200 for non-deliberate shrink prevention with prescriptive recommendations, according to an example embodiment. The software module(s) that implements the method 200 is referred to as a “non-deliberate shrink event predictor.” The non-deliberate shrink event predictor is implemented as executable instructions programmed and residing within memory and/or a non-transitory computer-readable (processor-readable) storage medium and executed by one or more processors of one or more devices. The processor(s) of the device that executes the non-deliberate shrink event predictor are specifically configured and programmed to process the non-deliberate shrink event predictor. The non-deliberate shrink event predictor has access to one or more network connections during its processing. The network connections can be wired, wireless, or a combination of wired and wireless.

In an embodiment, the device that executes the non-deliberate shrink event predictor is cloud 110. Cloud 110 comprises a plurality of servers logically cooperating and accessible as a single server 110. In an embodiment, the device that executes the non-deliberate shrink event predictor is retail server 140. In an embodiment, the non-deliberate shrink event predictor is all or some combination of 113 and/or 114.

At 210, the non-deliberate shrink event predictor labels specific features that are relevant to non-deliberate shrink within transaction data for a current interval of time. The current interval of time is a most-recent past interval of time during which transaction data for transactions of a store were collected.

In an embodiment, at 211, the non-deliberate shrink event predictor updates metrics maintained for the non-deliberate shrink based on the transaction data for the current interval of time. In an embodiment of 211 and at 212, the non-deliberate shrink event predictor maintains the metrics by cashier, by categories of cashiers (e.g., new cashiers, experienced cashiers, ratings for cashiers, etc.), and by cashiers as a whole for the store.

In an embodiment of 212 and at 213, the non-deliberate shrink event predictor labels the features from the transaction data. The features include, by way of example only, a size of a basket of items for each transaction defined within the transaction data, a time of day for each transaction (e.g., peak times of day, non-peak times of day, and times of day that corresponding to ends of shifts for the cashiers), a cashier identifier for each transaction, and an item category for each item of each transaction (e.g., produce, deli, bakery, etc.).

At 220, the non-deliberate shrink event predictor provides the labeled features to a model 114 as input. In an embodiment of 213 and 220, at 221, the non-deliberate shrink event predictor provides the metrics relevant to the non-deliberate shrink as additional input to the model 114.

At 230, and responsive to 220, the non-deliberate shrink event predictor receives predictions over a next interval of time as output from the model 114. Each prediction indicative of a likelihood that a corresponding cashier will be associated with a non-deliberate shrink event within the next interval of time.

In an embodiment of 221 and 230, at 231, the non-deliberate shrink event predictor receives at least one prescriptive recommendation for each prediction that exceeds a predefined value as additional output from the model 114. In an embodiment of 231, at 232, the non-deliberate shrink event predictor provides an interactive heatmap for the store that includes each prediction and a corresponding prescriptive recommendation.

At 240, the non-deliberate shrink event predictor provides the predictions to a device 120 operated by a manager of the store. In an embodiment, at 241, the non-deliberate shrink event predictor provides the predictions through an interactive heatmap of the store via an application programming interface. In an embodiment, at 242, the non-deliberate shrink event predictor pushes a device notification to the device 120 for at least one of the predictions when the corresponding prediction exceeds a predefined value.

In an embodiment, at 250, the non-deliberate shrink event predictor iterates to 210 when the next interval of future time expires. In other words, actual transaction data for the interval of future time is known since the future time is now past time. The actual transaction data becomes part of the next current interval of time at 210.

In an embodiment, at 260, the non-deliberate shrink event predictor periodically reports metrics relevant to the non-deliberate shrink or shrink events for the store. The report includes metrics on at least one of a per cashier basis, a per cashier category basis or across all cashiers of the store. The reports are sent to the device 120 through interface 123 via an application programming interface.

FIG. 3 is a diagram of another method 300 for non-deliberate shrink prevention with prescriptive recommendations, according to an example embodiment. The software module(s) that implements the method 300 is referred to as a “shrink event predictor and prescriptive recommendation manager.” The shrink event predictor and prescriptive recommendation manager is implemented as executable instructions programmed and residing within memory and/or a non-transitory computer-readable (processor-readable) storage medium and executed by one or more processors of a device. The processors that execute the shrink event predictor and prescriptive recommendation manager are specifically configured and programmed for processing the shrink event predictor and prescriptive recommendation manager. The shrink event predictor and prescriptive recommendation manager has access to one or more network connections during its processing. The network connections can be wired, wireless, or a combination of wired and wireless.

In an embodiment, the device that executes the shrink event predictor and prescriptive recommendation manager is cloud 110. In an embodiment, the device that executes the shrink event predictor and prescriptive recommendation manager is server 110. In an embodiment, the device that executes the shrink event predictor and prescriptive recommendation manager is retail server 140.

In an embodiment, the shrink event predictor and prescriptive recommendation manager is all of or some combination of 113, 114, and/or method 200 of FIG. 2. The shrink event predictor and prescriptive recommendation manager presents another and, in some ways, enhanced processing perspective from that which was discussed above for cloud 110 and method 200.

At 310, the shrink event predictor and prescriptive recommendation manager trains a model 114 on features relevant to non-deliberate shrink events to generate predictions for a next interval of time as to whether cashiers or a store are likely or not likely to cause a given non-deliberate shrink event in the next interval of future time. The features include any of the features discussed above with system 100 and method 200 or any combination of the features discussed.

At 320, the shrink event predictor and prescriptive recommendation manager obtains transaction data for a most-recent past interface of time for the store. At 330, the shrink event predictor and prescriptive recommendation manager labels the transaction data with the corresponding features.

At 340, the shrink event predictor and prescriptive recommendation manager provides the labeled features as input to the model 114. In an embodiment, at 341, the shrink event predictor and prescriptive recommendation manager provides up-to-date metrics for the non-deliberate shrink events by cashier as additional input to the model 114.

At 350, the shrink event predictor and prescriptive recommendation manager receives current predictions for a next interval of time as output from the model. In an embodiment of 341 and 350, at 351, the shrink event predictor and prescriptive recommendation manager receives at least one prescriptive recommendation per prediction as additional output from the model 114.

At 360, the shrink event predictor and prescriptive recommendation manager provides the current predictions through an interface 123 to a manager of a store. The manager uses the predictions to manage the next interval of time and mitigate occurrences of any of the non-deliberate shrink events by the cashiers.

In an embodiment, at 361, the shrink event predictor and prescriptive recommendation manager provides an interactive heatmap for the predictions and the corresponding recommendations through the interface 123. In an embodiment of 361 and at 362, the shrink event predictor and prescriptive recommendation manager animates or plays the interactive heatmap over the next interval of time within the interface 123.

In an embodiment, at 370, the shrink event predictor and prescriptive recommendation manager maintains up-to-date metrics for the non-deliberate shrink events. The metrics are based on at least one of a per cashier basis, a per cashier category basis or across all cashiers of the store. In an embodiment, of 370 and at 371, the shrink event predictor and prescriptive recommendation manager periodically generates a report for the metrics and provides the report through the interface 123 to the manager of the store.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
labeling features relevant to non-deliberate cashier shrink within transaction data for a current interval of time;
providing the labeled features to a machine learning model (model) as input;
receiving, as output from the model, predictions corresponding to a next interval of time, each prediction indicative of a likelihood that a corresponding cashier will be associated with a non-deliberate shrink event during the next interval of time; and
providing the predictions to a device operated by a manager of a store.

2. The method of claim 1, wherein labeling further includes updating metrics maintained for non-deliberate cashier shrink based on the transaction data for the current interval of time.

3. The method of claim 2, wherein updating further includes maintaining the metrics on at least one of a per-cashier basis, a per-cashier category basis, or across all cashiers of the store.

4. The method of claim 3, wherein labeling further includes labeling the features from the transaction data associated with a size of a basket of items for each transaction within the transaction data, a time of day associated with each transaction, a cashier identifier associated with each transaction, and an item category associated with each item of each transaction.

5. The method of claim 4, wherein providing the labeled features further includes providing the metrics as additional input to the model.

6. The method of claim 1, wherein receiving the predictions further includes receiving at least one prescriptive recommendation for each prediction that exceeds a predefined value as additional output from the model.

7. The method of claim 6, wherein receiving the at least one prescriptive recommendation further includes providing an interactive heatmap for the store that includes each prediction and a corresponding prescriptive recommendation.

8. The method of claim 1, wherein providing the predictions further include providing the predictions through an interactive heatmap of the store via an application programming interface.

9. The method of claim 1, wherein providing the predictions further includes pushing a device notification to the device for at least one of the predictions when the at least one of the predictions exceeds a predefined value.

10. The method of claim 1 further comprising, iterating to the labeling when the next interval of time expires.

11. The method of claim 1 further comprising:
periodically reporting metrics relevant to the non-deliberate shrink on at least one of a per cashier basis, a per cashier category basis or across all cashiers of the store.

12. A method, comprising:
training a machine learning model on features relevant to non-deliberate shrink events to generate predictions for a next interval of future time as to whether cashiers of a store are likely or not likely to cause a given non-deliberate shrink event in the next interval of future time;
obtaining transaction data for a most-recent past interval of time for the store;
labeling the transaction data with the features;
providing the labeled features as input to the model;
receiving current predictions for a next interval of time as output from the model; and
providing the current predictions through an interface to a manager of the store to manage the next interval of time and mitigate occurrences of any of the non-deliberate shrink events by the cashiers.

13. The method of claim 12 further comprising maintaining up-to-date metrics for the non-deliberate shrink events on at least one of per cashier basis, a per cashier category basis or across all cashiers of the store.

14. The method of claim 13 further comprising, periodically generating a report for the metrics and providing the report through the interface to the manager of the store.

15. The method of claim 12, wherein providing the labeled features further includes providing up-to-date metrics for the non-deliberate shrink events by cashier as additional input to the model.

16. The method of claim 15, wherein receiving further includes receiving at least one prescriptive recommendation per prediction as additional output from the model.

17. The method of claim 16, wherein providing the current predictions further includes providing an interactive heatmap for the predictions and corresponding prescriptive recommendations through the interface.

18. The method of claim 17, wherein providing the interactive heatmap further includes animating the interactive heatmap over the next interval of time within the interface.

19. A system, comprising:
a cloud processing environment comprising at least one server;
the at least one server comprising a processor and a non-transitory computer-readable storage medium;
the non-transitory computer-readable storage medium comprises executable instructions; and
the executable instructions when executed on the processor cause the processor to perform operations comprising:
training a machine learning model (model) on features relevant to non-deliberate shrink events and on metrics relevant to the non-deliberate shrink events to generate predictions and prescriptive recommendations for avoiding the non-deliberate shrink events;
obtaining transaction data for a store for a most-recent past interval of time;
updating the metrics based on the transaction data for the most-recent past interval of time;
labeling the features and providing the labeled features and the updated metrics as input to the model;
receiving current predictions and corresponding prescriptive recommendations as output from the model for a next interval of time; and
providing the current predictions and the corresponding prescriptive recommendations through an interface to a manager of the store for the manager to mitigate occurrences of any of the non-deliberate shrink events.

20. The system of claim 19, wherein the executable instructions further include additional executable instructions that further cause the processor to perform additional operations comprising:
periodically generating a report for the updated metrics on at least one of a per cashier basis, a per cashier category basis or across all cashiers of the store; and
providing the report to the manager through the interface.
